(19) United States
(12) Patent Application Publication
(10) Pub. No.: US 2008/0002039 A1
(43) Pub. Date: Jan. 3, 2008

(54) IMAGE PROCESSING METHODS AND SYSTEMS

(75) Inventor: Chih-Yen Wu, Taipei County (TW)

Correspondence Address: QUINTERO LAW OFFICE, PC, 2210 MAIN STREET, SUITE 200, SANTA MONICA, CA, 90405, US

(73) Assignee: LITE-ON TECHNOLOGY CORPORATION, TAIPEI (TW)

(21) Appl. No.: 11/551,649

(22) Filed: Oct. 20, 2006

(30) Foreign Application Priority Data
Jul. 3, 2006 (TW) TW95124140

(51) Int. Cl. H04N 5/76

(52) U.S. Cl. 348/231.2

(57) ABSTRACT

Image processing methods and systems. An image is captured, and location information corresponding thereto is retrieved. The image is recorded to an image file, and the location information is recorded to the image file. The capture location of the image is determined according to the location information in the image file.

### BACKGROUND OF THE INVENTION

1. Field of the Invention

The disclosure relates generally to image processing and more particularly to image processing methods and systems that record capture locations of respective images.

2. Description of the Related Art

Digital cameras with image sensors such as charge coupled device (CCD) or complementary metal oxide semiconductor (CMOS) have gradually replaced conventional film cameras. Digital cameras have become commonplace, due to ease of review and processing of captured images in related devices such as computers.

Generally, detailed image data such as exchange image file format (EXIF) information is recorded into digital photos during image capture. EXIF information comprises attribute and capture information, such as capture time, exposure time, shutter speed value, aperture value, exposure program, ISO speed ratings, and others. No consideration is made, however, for recording information regarding location of the image capture, making manual recording of capture locations for respective photos inconvenient and time-consuming.

### BRIEF SUMMARY OF THE INVENTION

Image processing methods and systems are provided.

In an embodiment of an image processing method, an image is captured, and location information corresponding thereto is retrieved. The image is recorded to an image file, and the location information is also recorded thereto. A capture location of the image is determined according to the location information in the image file.

In an embodiment of an image processing method, an image file is obtained. An image is read from the image file, and location information is also read therefrom. A capture location of the image is determined according to the location information.

An embodiment of an image processing system comprises an image sense unit, a location information generator, and a processing unit. The image sense unit captures an image. The location information generator generates location information. The processing unit receives the image and the location information. The processing unit records the image to an image file, and records the location information thereto.

An embodiment of an image processing system comprises at least an image positioning unit. The image positioning unit receives an image file, and reads an image and location information therefrom. The image positioning unit determines a capture location of the image according to the location information.

Image processing methods and systems may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an image processing system;

FIG. 2 is a flowchart of an embodiment of a method for image file generation;

FIG. 3 is an example of an image file format; and

FIG. 4 is a flowchart of an embodiment of an image processing method.

### DETAILED DESCRIPTION OF THE INVENTION

Image processing methods and systems are provided.

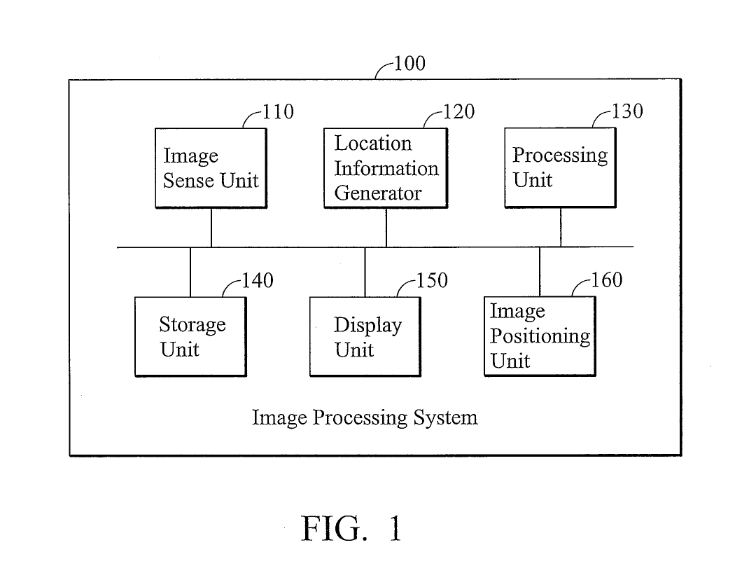

FIG. 1 is a schematic diagram illustrating an embodiment of an image processing system.

The image processing system 100 may be a digital camera, comprising an image sense unit 110, a location information generator 120, a processing unit 130, a storage unit 140, and a display unit 150. The image sense unit 110 may be a CCD or CMOS, capturing images. The location information generator 120 may be a global positioning system (GPS) receiver, receiving related signals from a plurality of satellites, and obtaining location information such as longitude and latitude data of the image processing system accordingly. The processing unit 130 may be an image encoder, such as a JPEG encoder. The processing unit 130 receives the captured image and the location information from the image sense unit 110 and location information generator 120, respectively, and combines the image and the location information to generate an image file. The storage unit 140 may be built-in memory or an external memory card, storing images captured by the image sense unit 110, location information generated by the location information generator 120, and image files generated by the processing unit 130. The display unit 150 may be a monitor of a digital camera or a display device coupled to the digital camera, displaying images or related operating interfaces for the image processing methods of the present invention. Additionally, the image processing system 100 further comprises an image positioning unit 160. The image positioning unit 160 receives image files. The image positioning unit 160 reads images and location information therefrom, and determines capture location of images according to the corresponding location information. It is understood that the image positioning unit 160 may be in the digital camera, or outside the digital camera. Details for the image positioning unit 160 are discussed later.

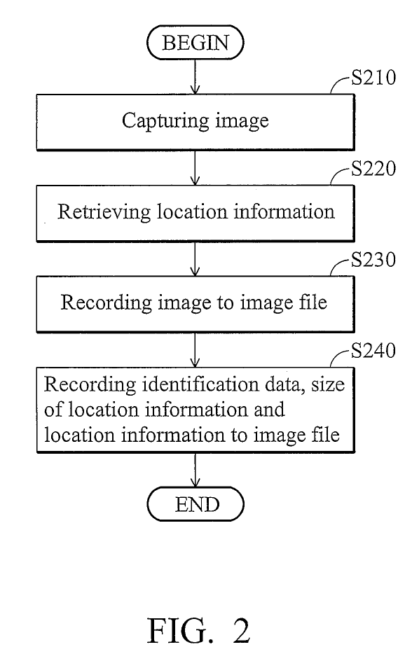

FIG. 2 is a flowchart of an embodiment of a method for image file generation

In step S210, an image is first captured using the image sense unit 110, and temporarily stored to the storage unit 140. Substantially, at the same time, in step S220, location information such as longitude and latitude data of the image processing system 100 is generated according to signals received by the location information generator such as a GPS receiver, and temporarily stored to the storage unit 140. In step S230, the processing unit 130 receives the image from the image sense unit 110, and records the image to an image file after related compression procedures. In step S240, the processing unit 130 receives the location information from the location information generator 120, and records specific identification data, a size of the location information, and the location information to the image file, thus completing the photograph procedure. It is understood that the identification data may be a predefined value such as “GPS” used to determine whether location information is in an image file.

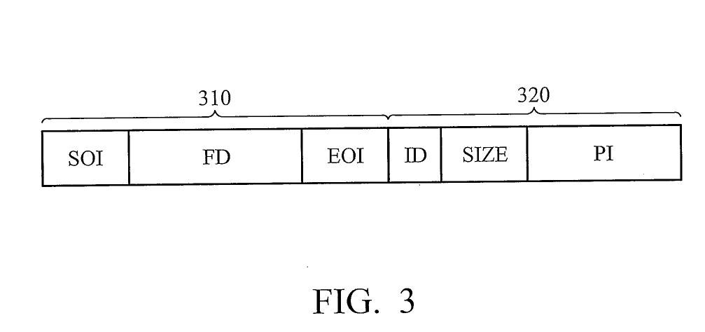

In some embodiments, the image file format comprises an image data area 310, and a location data area 320, as shown in FIG. 3. The image data area 310 records a start of an image (SOI), frame data (FD) of the image, and an end of the image (EOI) in sequence. The location data area 320 records identification data (ID), a size of location information (SIZE), and the location information (PI). The location data area 320 can be followed with the image data area 310 in the image file. It is understood that FIG. 3 is an example of image file format, and the disclosure is not limited thereto, being applicable with any image file format.

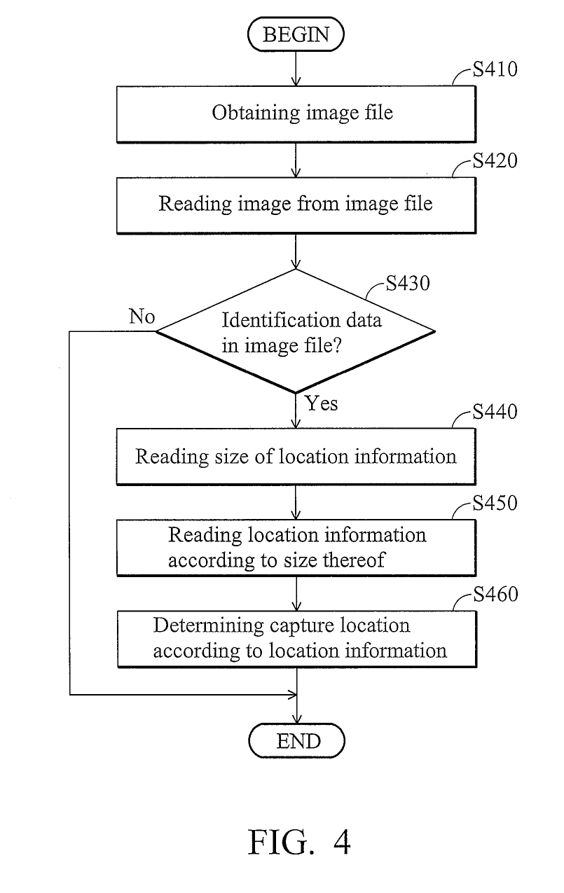

FIG. 4 is a flowchart of an embodiment of an image processing method

In step S410, the image positioning unit 160 obtains an image file. In step S420, an image is read from the image file. In step S430, it is determined whether specific identification data follows the image in the image file. If so, in step S440, a size of location information is read from the image file, and in step S450, location information is read from the image file according to the size of the location information. In step S460, a capture location of the image is determined according to the location information and a map database (not shown). It is understood that, in some embodiments, the capture location on a map can be marked, and displayed on the display unit 150. Further, capture locations for a sequence of images can be also determined according to the location information in the corresponding file images, and a capture route can be generated according to the capture locations and capture times of respective images.

Image processing methods and systems, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image processing method, comprising:
capturing an image;
retrieving location information corresponding to the image;
recording the image to an image file; and
recording the location information to the image file.

2. The method of claim 1 further comprising recording the location information following with the image in the image file.

3. The method of claim 1 further comprising recording identification data to the image file, the identification data serving to indicate the presence of the location information in the image file.

4. The method of claim 3 further comprising recording a size of the location information to the image file.

5. The method of claim 1 wherein the location information is obtained from a global positioning system receiver.

6. The method of claim 1 further comprising:
obtaining the image file;
reading the location information from the image file; and
determining a capture location of the image according to the location information.

7. The method of claim 4 further comprising:
obtaining the image file;
determining whether the identification data is present in the image file;
if so, reading the size of the location information from the image file;
reading the location information from the image file according to the size of the location information; and
determining a capture location of the image according to the location information.

8. An image processing method, comprising:
obtaining an image file;
reading an image from the image file;
reading location information from the image file; and
determining a capture location of the image according to the location information.

9. The method of claim 8 further comprising:
determining whether identification data is present in the image file;
if so, reading a size of the location information from the image file; and
reading the location information from the image file according to the size of the location information.

10. The method of claim 8 wherein the location information is recorded following with the image in the image file.

11. An image processing system, comprising:
an image sense unit capturing an image;
a location information generator retrieving location information; and
a processing unit receiving the image and the location information, recording the image to an image file, and recording the location information to the image file.

12. The system of claim 11 wherein the processing unit further records the location information following with the image in the image file.

13. The system of claim 11 wherein the processing unit further records identification data to the image file, the identification data serving to indicate the presence of the location information in the image file.

14. The system of claim 13 wherein the processing unit further records a size of the location information to the image file.

15. The system of claim 11 wherein the location information generator comprises a global positioning system receiver.

16. The system of claim 11 further comprising an image positioning unit obtaining the image file, reading the location information from the image file, and determining a capture location of the image according to the location information.

17. The system of claim 14 further comprising an image positioning unit obtaining the image file, determining whether the identification data is in the image file, and if so, reading the size of the location information from the image file, reading the location information from the image file according to the size of the location information, and determining a capture location of the image according to the location information.

18. An image processing system, comprising at least an image positioning unit obtaining an image file, reading an image from the image file, reading location information from the image file, and determining a capture location of the image according to the location information.

19. The system of claim 18 wherein the image positioning unit further determines whether identification data is present in the image file, and if so, reads a size of the location information from the image file, and reads the location information from the image file according to the size of the location information.

20. The system of claim 18 wherein the location information is recorded following with the image in the image file.
